(19) United States
(12) Patent Application Publication
(10) Pub. No.: US 2024/0072271 A1
(43) Pub. Date: Feb. 29, 2024

(54) SINGLE FUEL CELL, FUEL CELL CARTRIDGE, AND MANUFACTURING METHOD FOR SINGLE FUEL CELL

(71) Applicant: MITSUBISHI HEAVY INDUSTRIES, LTD., Tokyo (JP)

(72) Inventors: Shigenori Suemori, Tokyo (JP); Koji Miyamoto, Yokohama-shi, Kanagawa (JP)

(73) Assignee: MITSUBISHI HEAVY INDUSTRIES, LTD., Tokyo (JP)

(21) Appl. No.: 18/269,096

(22) PCT Filed: Dec. 21, 2021
(86) PCT No.: PCT/JP2021/047195

§ 371 Date: Jun. 22, 2023

(30) Foreign Application Priority Data
Dec. 28, 2020 (JP) 2020-218971

(51) Int. Cl. H01M 8/0282; H01M 8/0276

(52) U.S. Cl. CPC H01M 8/0282; H01M 8/0276; H01M 2008/1293

(57) ABSTRACT

A single fuel cell includes: a power generation part where an anode, an electrolyte, and a cathode are stacked; a non-power generation part that does not include the power generation part; and a gas seal film for at least partially covering a surface of the non-power generation part. The gas seal film includes a first layer and a second layer laminated to each other. The first layer has lower electronic conductivity than the second layer, and the second layer has lower oxygen ion conductivity than the first layer.

### TECHNICAL FIELD

The present disclosure relates to a single fuel cell, a fuel cell cartridge, and a manufacturing method for the single fuel cell.

This application claims the priority of Japanese Patent Application No. 2020-218971 filed on Dec. 28, 2020, the content of which is incorporated herein by reference.

### BACKGROUND

A fuel cell for generating power by chemically reacting a fuel gas and an oxidizing gas has characteristics such as excellent power generation efficiency and environmental responsiveness. Among these, a solid oxide fuel cell (SOFC) uses ceramics such as zirconia ceramics as an electrolyte and generates power by supplying, as a fuel gas, a gas such as a gasification gas obtained by producing hydrogen, city gas, natural gas, petroleum, methanol, and a carbon-containing raw material with a gasification facility, and causing reaction in a high-temperature atmosphere of approximately 700° C. to 1,000° C.

The solid oxide fuel cell may be provided with a gas seal film in order to prevent unwanted mixing of a fuel gas and an oxidizing gas. If functions of oxygen ion permeation and gas permeation prevention by the gas seal film are insufficient, oxygen or oxygen ions may penetrate from an oxidizing gas side to a fuel gas side via the gas seal film and the fuel gas is oxidized, which becomes a factor of causing a decrease in performance such as power generation efficiency.

Conventionally, the gas seal film of this type is made from a material such as YSZ (yttria-stabilized zirconia), as a dense film which is excellent in resistance to oxidation and resistance to reduction at high temperatures, and is dense enough to prevent passage of a fuel gas and an oxidizing gas. However, since the material such as YSZ has oxygen ion permeability, oxygen ions may penetrate from the oxidizing gas side to the fuel gas side due to a partial pressure difference between oxygen contained in the oxidizing gas and oxygen contained in the fuel gas. The material such as YSZ thus used for the conventional gas seal film has the problem of sealing characteristics against oxygen ions, and it is considered that an interconnector film is used as the gas seal film, as a measure for solving the problem. However, since the interconnector film has electronic conductivity, Patent Document 1 proposes a gas seal film whose insulating property is improved by adopting a material containing MTiO₃ (M: alkaline earth metal) and a metal oxide (excluding TiO₂ and YSZ).

### CITATION LIST

### Patent Literature

Patent Document 1: JP6633236B

### SUMMARY

### Technical Problem

Although an output voltage of a single fuel cell is as low as about 1 V per cell, the output voltage can be increased by connecting a plurality of single fuel cells in series. In recent years, for example, a fuel cell module whose output voltage reaches not less than 500 to 600 V has been developed. In such a high-voltage fuel cell module, problems are suppression of oxygen ion movement and a leakage current due to a potential difference between the single fuel cell and a peripheral component.

Patent Document 1 described above proposes improving a sealing property and insulating property of oxygen and oxygen ions from the oxidizing gas side to the fuel gas side by using the material containing MTiO₃ (M: alkaline earth metal) and the metal oxide (excluding TiO₂ and YSZ) as the material for the gas seal film. However, as the output voltage of the fuel cell module increases as described above, the insulating property is insufficient even if such material is used, which may make it impossible to sufficiently suppress the leakage current. For example, in a fuel cell module that includes a gas seal film which is formed from Sr_{0.9}La_{0.1}TiO₃ obtained by doping La into SrTiO₃ which is an example of this kind of material, a pronounced behavior in which the leakage current increases rapidly is exhibited if the output voltage exceeds a predetermined value. This is thought to be an influence by an electrification status of the surrounding component of the single fuel cell, and a further improvement is required in order to use this type of material for the fuel cell module having the high output voltage.

At least one embodiment of the present disclosure has been made in view of the above, and an object of the present disclosure is to provide a single fuel cell, a fuel cell cartridge, and a manufacturing method for the single fuel cell capable of preventing oxygen and oxygen ions from penetrating from an oxidizing gas side to a fuel gas side, and suppressing a leakage current to a peripheral component.

### Solution to Problem

In order to solve the above-described problems, a single fuel cell according to at least one embodiment of the present disclosure, includes: a power generation part where an anode, an electrolyte, and a cathode are stacked; a non-power generation part that does not include the power generation part; and a gas seal film for at least partially covering a surface of the non-power generation part. The gas seal film includes a first layer and a second layer laminated to each other. The first layer has lower electronic conductivity than the second layer. The second layer has lower oxygen ion conductivity than the first layer.

In order to solve the above-described problems, a fuel cell cartridge according to at least one embodiment of the present disclosure, includes: the single fuel cell according to at least one embodiment of the present disclosure; and a heat insulating body surrounding a power generation chamber including the single fuel cell. The gas seal film is disposed at a position opposite to the heat insulating body.

In order to solve the above-described problems, a manufacturing method for a single fuel cell according to at least one embodiment of the present disclosure, the single fuel cell including: a power generation part where an anode, an electrolyte, and a cathode are stacked; a non-power generation part that does not include the power generation part; a gas seal film for at least partially covering a surface of the non-power generation part; and a substrate tube for supporting the power generation part, the non-power generation part, and the gas seal film, the gas seal film including a first layer and a second layer laminated to each other, the first layer having lower electronic conductivity than the second layer, the second layer having lower oxygen ion conductivity than the first layer, the manufacturing method for the single fuel cell, including: a slurry application step of applying at least one of a first slurry which is a material constituting the first layer or a second slurry which is a material constituting the second layer onto a surface, of the substrate tube, corresponding to the non-power generation part; and a firing step of firing at least one of the first slurry or the second slurry together with a third slurry which is applied onto a surface, of the substrate tube, corresponding to the power generation part and is a material constituting the anode and the electrolyte.

### Advantageous Effects

According to at least one embodiment of the present disclosure, it is possible to provide a single fuel cell, a fuel cell cartridge, and a manufacturing method for the single fuel cell capable of suppressing a leakage current to a peripheral component while preventing oxygen and oxygen ions from penetrating from an oxidizing gas side to a fuel gas side.

### BRIEF DESCRIPTION OF DRAWINGS

FIG. 1 shows one aspect of a single fuel cell according to an embodiment of the present invention.

FIG. 2 shows another aspect of a single fuel cell according to an embodiment of the present invention.

FIG. 3 shows another aspect of a single fuel cell according to an embodiment of the present invention.

FIG. 4 is a schematic view showing a state of a withstand voltage test on the single fuel cell.

FIG. 5 is an example of withstand voltage test results of the single fuel cell according to comparative examples.

FIG. 6 is an example of withstand voltage test results of the single fuel cell in FIG. 1.

FIG. 7 is a flowchart showing one aspect of a manufacturing method for the single fuel cell according to an embodiment of the present invention.

FIG. 8 is a tomographic image of a gas seal film for the single fuel cell manufactured by the manufacturing method of FIG. 7.

FIG. 9 is a flowchart showing another aspect of the manufacturing method for the single fuel cell according to an embodiment of the present invention.

FIG. 10 is a tomographic image of the gas seal film for the single fuel cell manufactured by the manufacturing method of FIG. 9.

FIG. 11 is a schematic configuration view of a fuel cell cartridge according to an embodiment of the present disclosure.

### DETAILED DESCRIPTION

Hereinafter, an embodiment of a single fuel cell, a fuel cell cartridge, and a manufacturing method for the single fuel cell according to the present invention will be described with reference to the drawings.

Hereinafter, for descriptive convenience, positional relationships among respective components described by using expressions “upper” and “lower” with reference to the drawing indicate the vertically upper side and the vertically lower side, respectively. Further, in the present embodiment, as long as the same effect is obtained in the up-down direction and the horizontal direction, the up-down direction in the drawing is not necessarily limited to the vertical up-down direction but may correspond to, for example, the horizontal direction orthogonal to the vertical direction.

Furthermore, hereinafter, although a cylindrical (tubular) single fuel cell of a solid oxide fuel cell (SOFC) will be described as an example, the present invention is not necessarily limited thereto and, for example, a flat single fuel cell may be used. Although the single fuel cell is formed on a substrate, an electrode (an anode or a cathode) may thickly be formed instead of the substrate, and may also be used as the substrate.

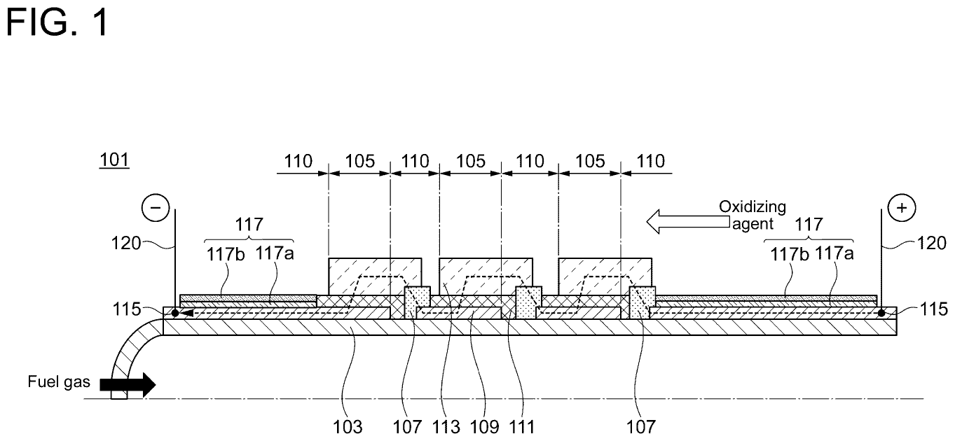

First, a single fuel cell 101 according to an embodiment of the present invention will be described with reference to FIG. 1. FIG. 1 shows one aspect of the single fuel cell 101 according to an embodiment of the present invention.

In FIG. 1, a cylindrical cell using a substrate tube will be described as one aspect of the single fuel cell. However, in a case where the substrate tube is not used, for example, an anode described later may be formed thick to also serve as the substrate tube and is not limited to be used as the substrate tube. Further, although the substrate tube in the present embodiment is described with the substrate tube having the cylindrical shape, the substrate tube can have a tubular shape, and a cross section of the substrate tube is not necessarily limited to a circular shape but may be, for example, an elliptical shape. A single fuel cell may be used which has, for example, a flat tubular shape obtained by vertically squeezing a circumferential side surface of the cylinder.

The single fuel cell 101 includes a cylindrical-shaped substrate tube 103, a plurality of power generation parts 105 formed on an outer circumferential surface of the substrate tube 103, and a non-power generation part 110 formed between the adjacent power generation parts 105. Each of the power generation parts 105 is formed by stacking an anode 109, an electrolyte 111, and a cathode 113. Further, the single fuel cell 101 includes a lead film 115 electrically connected via an interconnector 107 to the cathode 113 of the power generation part 105 formed at farthest one end of the substrate tube 103 in the axial direction and includes the lead film 115 electrically connected to the anode 109 of the power generation part 105 formed at farthest another end, among the plurality of power generation parts 105 formed on the outer circumferential surface of the substrate tube 103.

The non-power generation part 110 means a region that does not include the power generation part 105 in the single fuel cell 101. The single fuel cell 101 includes a gas seal film 117 for at least partially covering a surface of the non-power generation part 110. In FIG. 1, the gas seal film 117 is disposed on upper surfaces of the lead films 115 located in both end portions of the single fuel cell 101, or in other words, on surfaces of the lead films 115 opposite to the substrate tube 103 side. The lead films 115 are connected to current collector parts 120. The gas seal film 117 includes a first layer 117a and a second layer 117b laminated to each other, and a detailed configuration will be described later.

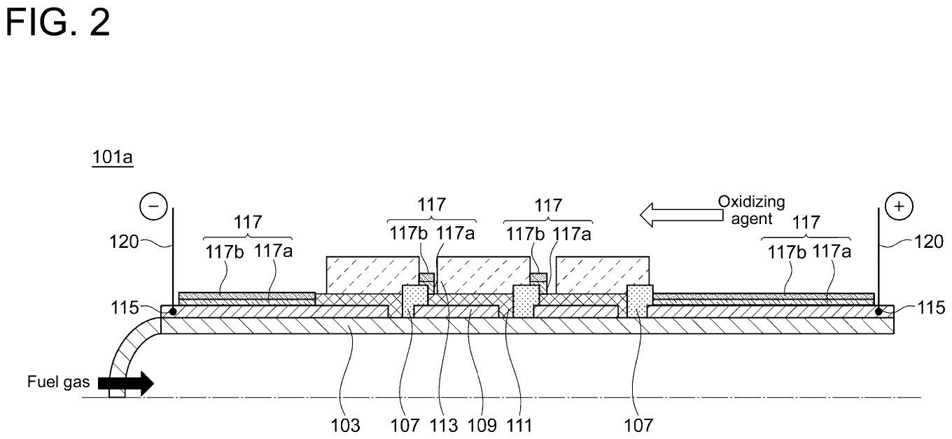

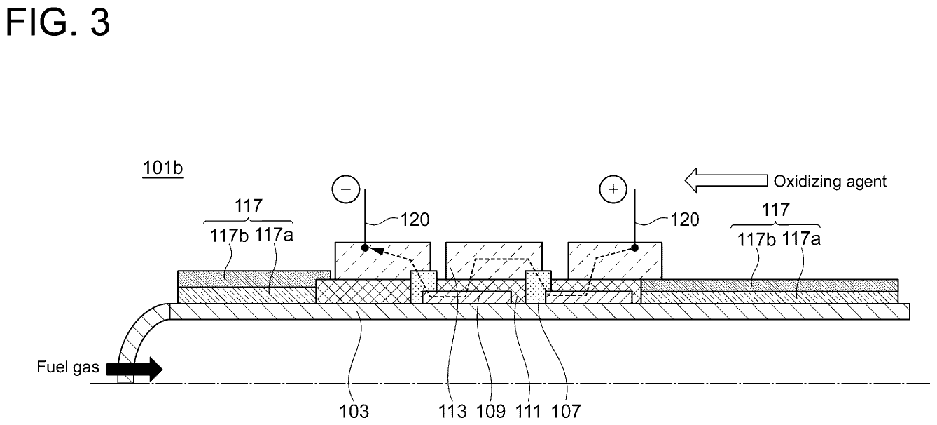

Herein, FIGS. 2 and 3 each show another aspect of the single fuel cell 101 according to an embodiment of the present invention. FIGS. 2 and 3 each show another arrangement example of the gas seal film 117. In a single fuel cell 101a of FIG. 2, the gas seal film 117 is disposed on the interconnector 107 whose surface is exposed without the cathode 113 being stacked and/or on the electrolyte 111, between the two cathodes 113 respectively belonging to the adjacent power generation parts 105. In a single fuel cell 101b of FIG. 3, the gas seal film 117 is disposed directly on the substrate tube 103 by omitting the lead film 115. In this case, the current collector parts 120 are connected to the cathode 113.

The arrangement of the gas seal film 117 is not limited to the aspects shown in FIGS. 1 to 3.

The side of the substrate tube 103 where the cathode 113 is disposed is brought into an oxidizing gas atmosphere during power generation. The inside of the substrate tube 103 is brought into a fuel gas atmosphere during power generation, and is purged with nitrogen and brought into a reducing atmosphere after the fuel gas is shut off during emergency stop. The oxidizing gas is a gas containing approximately 15% to 30% of oxygen, and air is representatively suitable. Besides air, however, a mixed gas of a combustion exhaust gas and air, a mixed gas of oxygen and air, or the like can be used. The fuel gas includes, for example a gasification gas produced from carbon-containing raw materials such as petroleum, methanol, and coal by a gasification facility, in addition to hydrocarbon gas such as hydrogen (H₂) and carbon monoxide (CO), methane (CH₄), city gas, or natural gas.

The substrate tube 103 is formed by firing a porous material, for example. The porous material includes, for example, CaO stabilized ZrO₂ (CSZ), a mixture (CSZ+NiO) of CSZ and nickel oxide (NiO), or Y₂O₃ stabilized ZrO₂ (YSZ), MgAl₂O₄ or the like as a main component. The substrate tube 103 supports the power generation part 105, the interconnector 107, and the lead film 115, and diffuses the fuel gas supplied to an inner circumferential surface of the substrate tube 103 to the anode 109, which is formed on the outer circumferential surface of the substrate tube 103, via a pore of the substrate tube 103.

The anode 109 is formed by firing a material which is an oxide of a composite material of Ni and a zirconia-based electrolyte material. For example, Ni/YSZ is used as the material of the anode 109. The anode 109 has a thickness of 50 μm to 250 μm, and the anode 109 may be formed by screen-printing a slurry. In this case, in the anode 109, Ni which is the component of the anode 109 has catalysis on the fuel gas. The catalysis reacts the fuel gas supplied via the substrate tube 103, for example, a mixed gas of methane (CH₄) and water vapor to be reformed into hydrogen (H₂) and carbon monoxide (CO). Further, the anode 109 electrochemically reacts hydrogen (H₂) and carbon monoxide (CO) obtained by the reformation with oxygen ions (O₂) supplied via the electrolyte 111 in the vicinity of the interface with the electrolyte 111 to produce water (H₂O) and carbon dioxide (CO₂), and generates power by emitting electrons.

As the electrolyte 111, YSZ is mainly used which has a gas-tight property that makes it difficult for a gas to pass through and high oxygen ion conductivity at high temperature. The electrolyte 111 moves the oxygen ions (O₂) produced at an interface with the cathode to the anode 109. The electrolyte 111 located on a surface of the anode 109 has a film thickness of 10 μm to 100 μm, and the electrolyte 111 may be formed by screen-printing the slurry.

The cathode 113 is formed by firing a material composed of a LaSrMnO₃-based oxide or a LaCoO₃-based oxide, for example. The cathode 113 may be formed by applying a slurry of the material by using screen-printing or a dispenser. The cathode 113 ionizes oxygen molecules in the oxidizing gas such as supplied air to generate oxygen ions (O²⁻), in the vicinity of the interface with the electrolyte 111.

The cathode 113 can also have a two-layer structure. In this case, a cathode layer (cathode intermediate layer) on the electrolyte 111 side is made of a material which shows high oxygen ion conductivity and is excellent in catalytic activity. A cathode layer (cathode conductive layer) on the cathode intermediate layer may be composed of a perovskite-type oxide represented by Ca-doped LaMnO₃ and Sr having higher conductivity. Thus, it is possible to further improve power generation performance.

The interconnector 107 is formed by firing a material which is composed of a conductive perovskite-type oxide represented by M₁₋ₓLₓTiO³ (M is an alkaline earth metal element, L is a lanthanoid element) such as of SrTiO₃-based. The interconnector 107 may be formed by screen-printing the slurry of the material. The interconnector 107 has a dense film so that the fuel gas and the oxidizing gas do not mix with each other. Further, the interconnector 107 is required to have stable durability and electronic conductivity under both the oxidizing atmosphere and the reducing atmosphere. In the adjacent power generation parts 105, the interconnector 107 is configured to electrically connect the cathode 113 of the one power generation part 105 and the anode 109 of another power generation part 105, and to connect the adjacent power generation parts 105 to each other in series.

The lead film 115 needs to have electronic conductivity and to have a thermal expansion coefficient close to that of another material constituting the single fuel cell 101. Thus, the lead film 115 is formed by firing the material which is composed of a composite material of a zirconia-based electrolyte material and Ni such as Ni/YSZ or M₁₋ₓLₓTiO₃ (M is an alkaline earth metal element, L is a lanthanoid element) such as of SrTiO₃-based, for example. The lead film 115 is configured to derive the DC power which is generated in the plurality of power generation parts 105 connected in series by the interconnector 107 to the vicinity of the end portion of the single fuel cell 101.

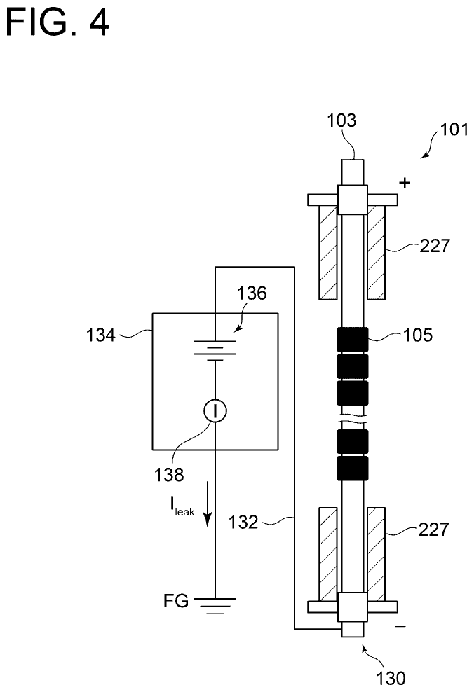

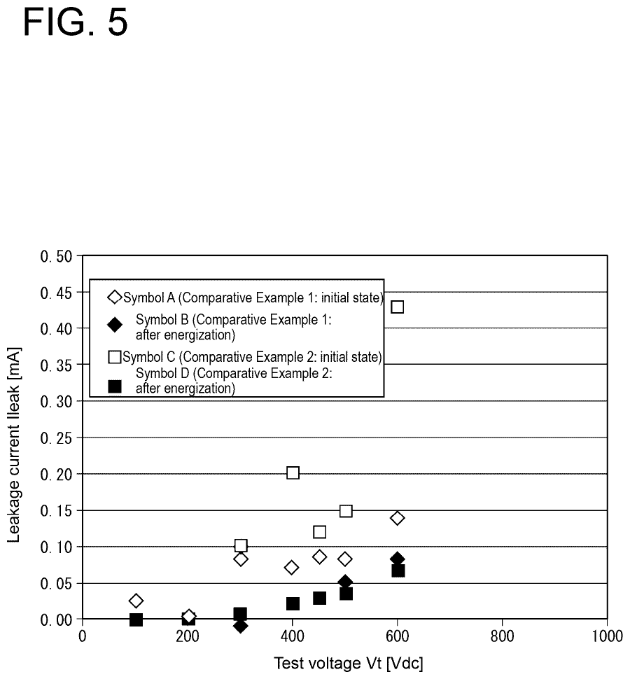

The gas seal film 117 is configured as the dense film so that the fuel gas and the oxidizing gas do not mix with each other. Before describing the gas seal film 117 in detail, the underlying technology will first be described here based on results of a withstand voltage test performed on the single fuel cell 101 according to comparative examples. FIG. 4 is a schematic view showing a state of the withstand voltage test on the single fuel cell 101, and FIG. 5 is an example of the withstand voltage test results of the single fuel cell 101 according to the comparative examples.

In the withstand voltage test on the single fuel cell 101, as shown in FIG. 4, an output end 130 of the single fuel cell 101 is electrically connected to a ground point FG via a measurement line 132. The single fuel cell 101 includes the plurality of power generation parts 105 connected in series by the interconnector 107 (see FIGS. 1 to 3) as described above, and the DC power generated by the plurality of power generation parts 105 is led to the output end 130 via the lead film 115 (see FIGS. 1 to 3).

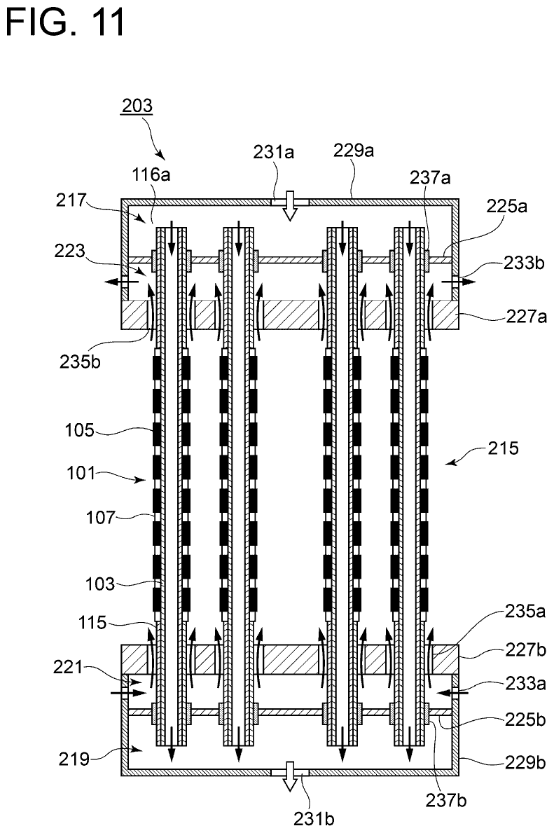

Further, in FIG. 4, heat insulating bodies 227 are disposed on the outer side in the vicinity of the end portions of the single fuel cell 101. This is for simply simulating a configuration where in a fuel cell cartridge including the single fuel cell 101, the single fuel cell 101 is inserted through hole portions that are disposed in the heat insulating bodies 227 for at least partially surrounding the power generation part which is in a high-temperature environment (an oxidant exhaust gap 235b disposed in an upper heat insulating body 227a and an oxidant supply gap 235a disposed in a lower heat insulating body 227b), and a leakage current heal, is likely to occur when the single fuel cell 101 contacts the heat insulating bodies 227, as will be described later with reference to FIG. 11.

The heat insulating bodies 227 contain colloidal silica for improving workability and Na added for stabilizing colloidal silica.

A withstand voltage tester 134 is disposed on the measurement line 132. The withstand voltage tester 134 includes a power supply 136 (DC power supply) and a leakage current measurement part 138. The power supply 136 and the leakage current measurement part 138 are disposed in series on the measurement line 132. The power supply 136 applies a test voltage Vt between the ground point FG and the output end 130 of the single fuel cell 101. The leakage current measurement part 138 is configured to measure the leakage current Leak flowing through measurement line 132 at that time.

FIG. 5 shows the withstand voltage test results for Comparative Example 1 and Comparative Example 2, which have the gas seal films 117 formed from different single materials, respectively. Comparative Example 1 includes the gas seal film 117 formed of YSZ (yttria-stabilized zirconia), and Comparative Example 2 includes the gas seal film 117 formed of an alkaline earth metal-doped titanate MTiO₃ (M: alkaline earth metal), or more specifically, a material containing La-doped SrTiO₃ and a metal oxide.

In Comparative Example 1 and Comparative Example 2, the configuration other than the gas seal film 117 is the same as that of the aforementioned embodiment.

Comparative Example 1 shows that the leakage current Leak tends to gradually increase as the test voltage Vt rises when the test voltage Vt is applied to the single fuel cell 101 which is in an initial state (before voltage application) (see symbol A in FIG. 5), but Comparative Example 1 shows that the leakage current Leak is relatively small and electronic conductivity is low (electrical insulating property is good). However, as also mentioned in the aforementioned Patent Document 1, although the material such as YSZ is formed by densifying the electrolyte and has the high density to the extent that the gas does not pass through, the material such as YSZ has oxygen ion permeability, arising the problem in that the effect of preventing the oxygen ion penetration due to the partial pressure difference between oxygen contained in the oxidizing gas and oxygen contained in the fuel gas is limited.

As indicated by symbol B in FIG. 5, the relationship between the test voltage Vt and the leakage current Leak when the test voltage Vt was applied for a predetermined period (10 minutes) was substantially the same as symbol A.

Comparative Example 2 shows that the leakage current Leak tends to gradually increase as the test voltage Vt rises in a range where the test voltage Vt is relatively low as about not higher than 500 V in the initial state, but the leakage current Leak tends to rapidly increase when the test voltage Vt reaches not less than a certain value (not less than approximately 600 V) (see symbol C in FIG. 5). In the aforementioned Patent Document 1, the material containing alkaline earth metal-doped titanate MTiO₃ (M: alkaline earth metal) and the metal oxide in Comparative Example 2 is excellent in oxygen ion penetration prevention effect relative to the material such as YSZ used in Comparative Example 1. However, it is shown that since the material containing alkaline earth metal-doped titanate MTiO₃ (M: alkaline earth metal) and the metal oxide in Comparative Example 2 has a certain degree of electronic conductivity, the initial leakage current Leak cannot sufficiently be suppressed in a high-voltage region.

Further, as indicated by symbol D in FIG. 5, in Comparative Example 2, according to the relationship between the test voltage Vt and the leakage current Leak when the test voltage Vt was applied for the predetermined period (10 minutes), the rapid increase in the leakage current Leak in the high-voltage region as in the initial state does not appear. From this, it is considered that the rapid increase in the leakage current Leak in the high-voltage region in the initial state is affected by the electrification state of the peripheral component of the single fuel cell 101.

In order to solve such problem in the comparative examples, the single fuel cell 101 according to the present embodiment includes the gas seal film 117 which has a laminated structure including the first layer 117a and the second layer 117b laminated to each other. The first layer 117a is configured to have lower electronic conductivity than the second layer 117b, making it possible to effectively reduce the leakage current Leak that may be caused by a potential difference between the first layer 117a and the peripheral component. The second layer 117b is configured to have lower oxygen ion conductivity than the first layer 117a, making it possible to obtain a good oxygen ion penetration prevention effect. Since the single fuel cell 101 includes the gas seal film 117 having such configuration, it is possible to suppress the leakage current Leak to the peripheral component while preventing oxygen ions from penetrating from the oxidizing gas side to the fuel gas side.

The first layer 117a is formed by firing a material such as stabilized zirconia (general term for homogeneous phase zirconia in which a metal oxide having a different valence from zirconium is solid-dissolved), for example. The first layer 117a may be formed by screen-printing the slurry of the material.

The second layer 117b is formed by firing the material containing alkaline earth metal-doped titanate MTiO₃ (M: alkaline earth metal) and a metal oxide. Alkaline earth metal is either Mg, Ca, Sr, or Ba. The alkaline earth metal is preferably Sr or Ba. The metal oxide is B₂O₃, Al₂O₃, Ga₂O₃, In₂O₃, Tl₂O₃, Fe₂O₃, Fe₃O₄, MgO, NiO, SiO₂, or the like. The metal oxide is added at least 3 mol % with respect to MTiO₃. The metal oxide is added up to 100 mol % with respect to MTiO₃.

The thickness of the gas seal film 117 is, for example, 1 μm to 100 μm. The ratio of each of the first layer 117a and the second layer 117b in the thickness can be set optionally. For example, the ratio can be decided by a balance between the electronic insulating property and the oxygen ion insulating property required for the gas seal film 117. More specifically, when it is required to preferentially improve the electronic insulating property, the occupancy ratio of the first layer 117a may be increased. Further, when it is required to preferentially improve the oxygen ion insulating property, the occupancy ratio of the second layer 117b may be increased.

Furthermore, the first layer 117a and the second layer 117b composing the gas seal film 117 may be laminated in any order, but in the present embodiment, a case is exemplified in which the second layer 117b is disposed on the first layer 117a. Even if the peripheral component contacts the outside of the single fuel cell 101, the potential difference between the first layer 117a and the peripheral component is reduced by interposing the second layer 117b between the first layer 117a and the peripheral component, making it possible to more effectively suppress the penetration of oxygen ions from the outside of the cell. Further, if the peripheral component contacts the outside of the single fuel cell 101, the leakage current Leak) from the peripheral component to the lead film 115 can effectively be suppressed by interposing the first layer 117a having lower electronic conductivity than the second layer 117b between the second layer 117b and the lead film.

The gas seal film 117 may have a laminated structure of not less than three layers by including at least either of the plurality of first layers 117a or the plurality of second layers 117b. In this case, by increasing the number of layers of the gas seal film 117, it is possible to improve the strength of the gas seal film 117 and to more effectively prevent a defect, such as a crack, when each layer is fired as described later.

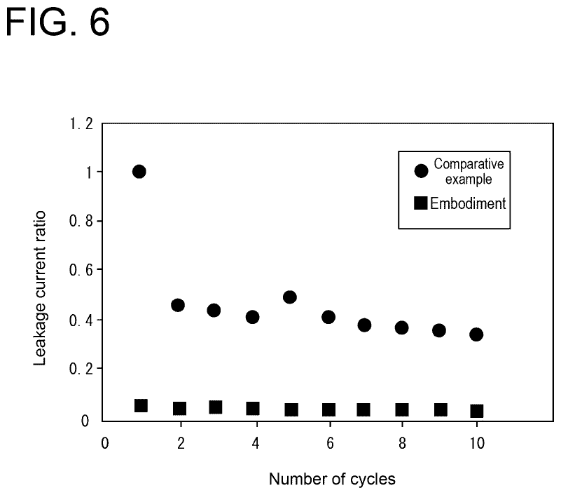

FIG. 6 is an example of withstand voltage test results of the single fuel cell 101 in FIG. 1 (the method for the withstand voltage test is as described above with reference to FIG. 4). FIG. 6 shows the leakage current heal, when the test voltage Vt=550 V is applied to the single fuel cell 101 for the predetermined period (10 minutes). This withstand voltage test shows the transition of the leakage current Leak when such test voltage Vt is repeatedly applied at predetermined intervals (10 minutes) (the number of cycles indicated on the horizontal axis means the number of repetitions).

As a comparative example, FIG. 6 shows the withstand voltage test results for the single fuel cell in which the gas seal film 117 is formed from SLT.

According to the withstand voltage test results of FIG. 6, in the comparative example, it is shown that the leakage current Leak is relatively large even after the second cycle. By contrast, it was verified that in the single fuel cell 101 according to the present embodiment, the leakage current Leak can be suppressed to about ⅕ compared to a single fuel cell 101′ according to the comparative example, and the leakage current Leak is effectively suppressed with stability regardless of the number of cycles. From this result, it is proved that the single fuel cell 101 according to the present embodiment, which includes the gas seal film 117 composed of the first layer 117a and the second layer 117b, can achieve both the electronic insulating property and the oxygen ion insulating property at a high level, and even in a single fuel cell with a high output voltage, it is possible to suppress the leakage current to peripheral component while preventing oxygen ions from penetrating from the oxidizing gas side to the fuel gas side.

(Manufacturing Method for Single Fuel Cell)

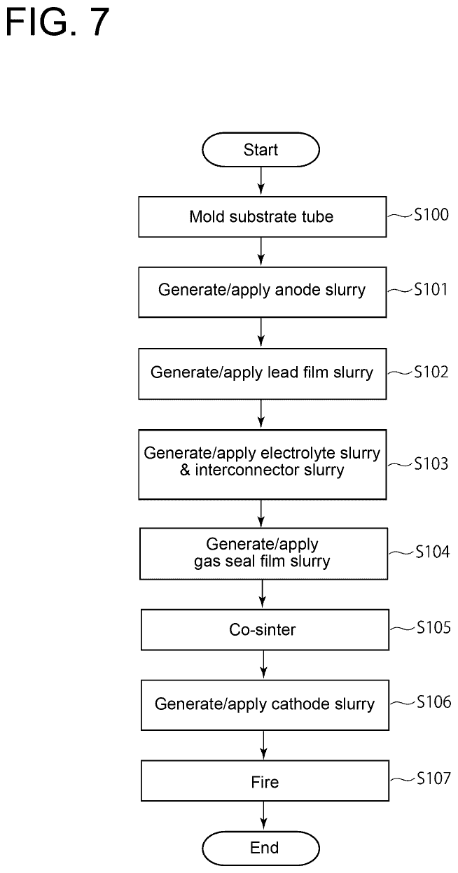

Next, a manufacturing method for the single fuel cell 101 shown in FIG. 1 will be described. FIG. 7 is a flowchart showing one aspect of the manufacturing method for the single fuel cell 101 according to an embodiment of the present invention.

First, a material such as calcia-stabilized zirconia (CSZ) is molded into the shape of the substrate tube 103 by extrusion molding (step S100).

An anode slurry is produced by mixing the material constituting the anode 109 with an organic vehicle (an organic solvent added with a dispersant, a binder) or the like, and the anode slurry is applied onto the substrate tube 103 by screen printing (step S101). The anode slurry is applied in a circumferential direction on the outer circumferential surface of the substrate tube 103 in a plurality of areas corresponding to the number of elements of the power generation part 105. The film thickness of the slurry formed by the application is appropriately set such that the anode 109 has a predetermined film thickness after sintering described later.

Subsequently, the material constituting the lead film 115 is mixed with the organic vehicle or the like to produce a lead film slurry, and the lead film slurry is applied onto the substrate tube 103 by screen printing (step S102). The anode slurry has already been applied onto the substrate tube 103 as described in step S101, and the lead film slurry is applied so as to at least partially cover the anode slurry. The film thickness of the slurry formed by the application is appropriately set such that the lead film 115 has a predetermined film thickness after sintering described later.

Subsequently, the material constituting the electrolyte 111 and the material constituting the interconnector 107 are mixed with the organic vehicle or the like to produce an electrolyte slurry and an interconnector slurry, respectively, and the electrolyte slurry and the interconnector slurry are sequentially applied onto the substrate tube 103 by screen printing (step S103). The anode slurry and the lead film slurry have already been applied onto the substrate tube 103 as described in steps S101 and S102, and the electrolyte slurry and the interconnector slurry are applied so as to at least partially cover the anode slurry and the lead film slurry. More specifically, the electrolyte slurry is applied onto the outer surface of the anode 109 and onto the substrate tube 103 between the adjacent anodes 109. The interconnector slurry is applied in the circumferential direction of the outer circumferential surface of the substrate tube 103 at a position corresponding to between the adjacent power generation parts 105. The film thickness of the slurry formed by the application is appropriately set such that the electrolyte 111 and the interconnector 107 each have a predetermined film thickness after sintering described later.

Subsequently, the material constituting the gas seal film 117 is mixed with the organic vehicle or the like to produce a gas seal film slurry, and the gas seal film slurry is applied onto the substrate tube 103 by screen printing (step S104). In the present embodiment, a first gas seal film slurry corresponding to the first layer 117a and a second gas seal film slurry corresponding to the second layer 117b are produced by mixing materials which respectively correspond to the first layer 117a and the second layer 117b composing the gas seal film 117 with the organic vehicle or the like. Then, the first gas seal film slurry and the second gas seal film slurry are applied onto the lead film 115 and the substrate tube 103 according to the lamination order of the first layer 117a and the second layer 117b. The film thickness of the slurry formed by the application is appropriately set such that the gas seal film 117 has a predetermined film thickness after sintering described later.

The substrate tube 103 applied with the above-described slurries is co-sintered in the air (in an oxidizing atmosphere) (step S105). The sintering conditions are specifically 1,350° C. to 1,450° C. (first sintering temperature) for 3 to 5 hours. Co-sintering under the above-described conditions forms the gas seal film 117 having a laminated structure composed of the first layer 117a and the second layer 117b.

Next, the material constituting the cathode 113 is mixed with the organic vehicle or the like to produce a cathode slurry, and the cathode slurry is applied onto the substrate tube 103 after co-sintering (step S106). The cathode slurry is applied to predetermined positions on the outer surface of the electrolyte 111 and on the interconnector 107. The film thickness of the slurry formed by the application is appropriately set such that the cathode 113 has a predetermined film thickness after firing.

After the application of the cathode slurry, firing is performed in the atmosphere (in the oxidizing atmosphere) at 1,100° C. to 1,250° C. (second sintering temperature) for 1 to 4 hours (step S107). The firing temperature of the cathode slurry is lower than the co-sintering temperature when the substrate tube 103 to the gas seal film 117 are formed (that is, the second sintering temperature is set lower than the first sintering temperature).

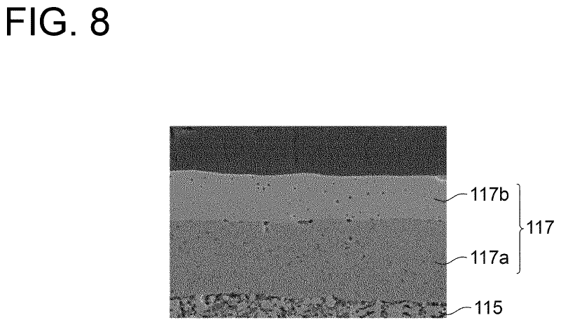

FIG. 8 is a tomographic image of the gas seal film 117 for the single fuel cell 101 manufactured by the manufacturing method of FIG. 7. In this manufacturing method, since both the first layer 117a and the second layer 117b composing the gas seal film 117 are formed by being sintered at the high first sintering temperature described above in step S105 of FIG. 7, as shown in FIG. 8, it was confirmed that the first layer 117a and the second layer 117b are each formed as a dense film with few voids within a tissue.

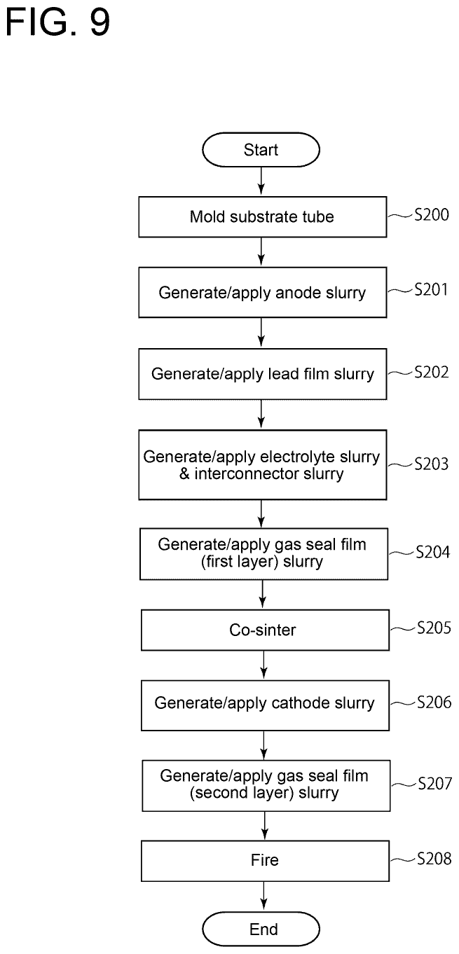

FIG. 9 is a flowchart showing another aspect of the manufacturing method for the single fuel cell 101 according to an embodiment of the present invention. Steps S201 to S203 of FIG. 9 are the same as steps S101 to S103 of FIG. 7, and thus a description of steps S201 to S203 of FIG. 9 will be omitted.

Step S204 includes mixing the material constituting the first layer 117a disposed on a lower layer side of the gas seal film 117 with the organic vehicle or the like to produce the gas seal film slurry, and applying the gas seal film slurry onto the lead film 115 and the substrate tube 103 by screen printing. The film thickness of the slurry formed by the application is appropriately set such that the first layer 117a has a predetermined film thickness after sintering described later.

As with step S105 described above, step S205 includes co-sintering the substrate tube 103 applied with the above-described slurry in the air (in the oxidizing atmosphere). The sintering conditions are specifically 1,350° C. to 1,450° C. (first sintering temperature) for 3 to 5 hours. Co-sintering under the above-described conditions forms the first layer 117a of the gas seal film 117.

As with step S106 described above, step S206 includes mixing the material constituting the cathode 113 with the organic vehicle or the like to produce the cathode slurry, and applying the cathode slurry onto the substrate tube 103 after co-sintering. The cathode slurry is applied to predetermined positions on the outer surface of the electrolyte 111 and on the interconnector 107. The film thickness of the slurry formed by the application is appropriately set such that the cathode 113 has a predetermined film thickness after firing.

Subsequently, the material constituting the second layer 117b disposed on an upper layer side of the gas seal film 117 is mixed with the organic vehicle or the like to produce the gas seal film slurry, and the gas seal film slurry is applied onto the first layer 117a of the gas seal film by screen printing (step S207). The film thickness of the slurry formed by the application is appropriately set such that the second layer 117b has a predetermined film thickness after sintering described later.

Then, the substrate tube 103 further applied with the above-described slurries is sintered in the air (in the oxidizing atmosphere) (step S208). The sintering conditions are specifically 1,100° C. to 1,250° C. (second sintering temperature) for 1 to 4 hours. The second firing temperature in step S208 is lower than the first sintering temperature when the substrate tube 103 to the gas seal film 117 are formed in step S205. Sintering under the above-described conditions forms the second layer 117b of the gas seal film 117 together with the cathode 113.

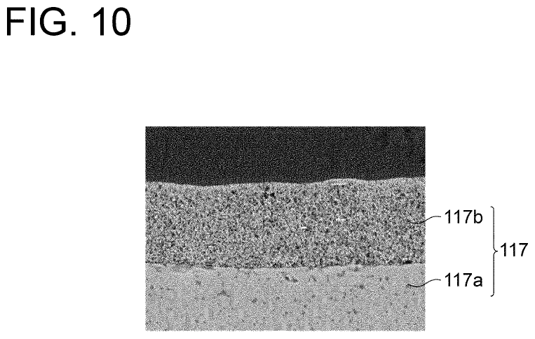

FIG. 10 is a tomographic image of the gas seal film 117 for the single fuel cell 101 manufactured by the manufacturing method of FIG. 9. In this manufacturing method, since the first layer 117a disposed on the lower layer side of the gas seal film 117 is sintered at the high first sintering temperature, as shown in FIG. 8, it was confirmed that the first layer 117a is formed as the dense film with few voids within the tissue. On the other hand, since the second layer 117b is sintered at the second sintering temperature lower than the first sintering temperature, as shown in FIG. 8, it was confirmed that the second layer 117b is formed as a film without any cracks or separation, though the second layer 117b has more voids within the tissue than the first layer 117a. As described above, in the present manufacturing method, since the second layer 117b is sintered at the low temperature relative to the first layer 117a, it is possible to effectively reduce the possibility of the defect, such as the crack, occurring during manufacturing.

FIG. 9 exemplifies the case where the first layer 117a is formed first in step S205 since the first layer 117a is disposed on the lower layer side in the gas seal film 117. However, if the layer 117b is disposed on the lower layer side in the gas seal film 117, the second layer 117b may be formed first in step S205. In this case, the first layer 117a is formed in step S208.

Next, the fuel cell cartridge 203 including the above-described single fuel cell 101 will be described. FIG. 11 is a schematic configuration view of the fuel cell cartridge 203 according to an embodiment of the present disclosure.

The fuel cell cartridge 203 includes the plurality of single fuel cells 101, a power generation chamber 215, a fuel gas supply header 217, a fuel gas exhaust header 219, an oxidant (air) supply header 221, and an oxidant exhaust header 223. Further, the fuel cell cartridge 203 includes an upper tube plate 225a, a lower tube plate 225b, the upper heat insulating body 227a, and the lower heat insulating body 227b.

In the present embodiment, the fuel gas supply header 217, the fuel gas exhaust header 219, the oxidant supply header 221, and the oxidant exhaust header 223 are disposed as shown in FIG. 11, whereby the fuel cell cartridge 203 has a structure where the fuel gas and the oxidizing gas oppositely flow inside and outside the single fuel cell 101. However, this is not always necessary and, for example, the fuel gas and the oxidizing gas may flow in parallel on the inner side and the outer side of the single fuel cell 101 or the oxidizing gas may flow in a direction orthogonal to the longitudinal direction of the single fuel cell 101.

The power generation chamber 215 is an area formed between the upper heat insulating body 227a and the lower heat insulating body 227b. The power generation chamber 215 is an area in which the power generation part 105 of the single fuel cell 101 is disposed, and is an area in which the fuel gas and the oxidizing gas are electrochemically reacted to generate power. Further, a temperature in the vicinity of the central portion of the power generation chamber 215 in the longitudinal direction of the single fuel cell 101 is monitored by a temperature measurement part (a temperature sensor, a thermocouple, etc.), and is brought into a high temperature atmosphere of approximately 700° C. to 1,000° C. during a steady operation.

The fuel gas supply header 217 is an area surrounded by an upper casing 229a and the upper tube plate 225a of the fuel cell cartridge 203, and communicates with a fuel gas supply branch pipe (not shown) through a fuel gas supply hole 231a disposed in the upper portion of the upper casing 229a. Further, the plurality of single fuel cells 101 are joined to the upper tube plate 225a by a sealing member 237a, and the fuel gas supply header 217 is configured to introduce the fuel gas, which is supplied via the fuel gas supply hole 231a, into substrate tubes 103 of the plurality of single fuel cells 101 at the substantially uniform flow rate and substantially uniformize the power generation performance of the plurality of single fuel cells 101.

The fuel gas exhaust header 219 is an area surrounded by a lower casing 229b and the lower tube plate 225b of the fuel cell cartridge 203, and communicates with a fuel gas exhaust branch pipe (not shown) through a fuel gas exhaust hole 231b provided in the lower casing 229b. Further, the plurality of single fuel cells 101 are joined to the lower tube plate 225b by a sealing member 237b, and the fuel gas exhaust header 219 is configured to collect the exhaust fuel gas, which is supplied to the fuel gas exhaust header 219 through the inside of the substrate tubes 103 of the plurality of single fuel cells 101, and exhaust the collected exhaust fuel gas via the fuel gas exhaust hole 231b.

The oxidant supply header 221 is an area surrounded by the lower casing 229b, the lower tube plate 225b, and the lower heat insulating body 227b of the fuel cell cartridge 203, and communicates with an oxidant supply branch pipe (not shown) through an oxidant supply hole 233a disposed in a side surface of the lower casing 229b. The oxidant supply header 221 is configured to introduce the predetermined flow rate of the oxidizing gas, which is supplied from the oxidant supply branch pipe (not shown) via the oxidant supply hole 233a, to the power generation chamber 215 via an oxidant supply gap 235a described later.

The oxidant exhaust header 223 is an area surrounded by the upper casing 229a, the upper tube plate 225a, and the upper heat insulating body 227a of the fuel cell cartridge 203, and communicates with an oxidant exhaust branch pipe (not shown) through an oxidant exhaust hole 233b disposed in a side surface of the upper casing 229a. The oxidant exhaust header 223 is configured to introduce the exhaust oxidized gas, which is supplied to the oxidant exhaust header 223 via an oxidant exhaust gap 235b described later, from the power generation chamber 215 to the oxidant exhaust branch pipe (not shown) via the oxidant exhaust hole 233b.

The upper tube plate 225a is fixed to side plates of the upper casing 229a such that the upper tube plate 225a, a top plate of the upper casing 229a, and the upper heat insulating body 227a are substantially parallel to each other, between the top plate of the upper casing 229a and the upper heat insulating body 227a. Further, the upper tube plate 225a has a plurality of holes corresponding to the number of single fuel cells 101 provided in the fuel cell cartridge 203, and the single fuel cells 101 are inserted into the holes, respectively. The upper tube plate 225a is configured to air-tightly support one end portion of each of the plurality of single fuel cells 101 via either or both of the sealing member 237a and an adhesive material, and isolate the fuel gas supply header 217 from the oxidant exhaust header 223.

The upper heat insulating body 227a is disposed at a lower end portion of the upper casing 229a such that the upper heat insulating body 227a, the top plate of the upper casing 229a, and the upper tube plate 225a are substantially parallel to each other, and is fixed to the side plates of the upper casing 229a. Further, the upper heat insulating body 227a includes the plurality of oxidant exhaust gaps 235b corresponding to the number of single fuel cells 101 provided in the fuel cell cartridge 203. Each of the oxidant exhaust gaps 235b is formed into a hole shape in the upper heat insulating body 227a, and a diameter of the oxidant exhaust gap 235b is set larger than an outer diameter of the single fuel cell 101 passing through the oxidant exhaust gap 235b.

The upper heat insulating body 227a is configured to separate the power generation chamber 215 and the oxidant exhaust header 223, and suppress an increase in corrosion by an oxidizing agent contained in the oxidizing gas or a decrease in strength due to an increased temperature of the atmosphere around the upper tube plate 225a. The upper tube plate 225a or the like is made of a metal material, such as inconel, having high temperature durability, and the upper heat insulating body 227a is configured to prevent thermal deformation which is caused by exposing the upper tube plate 225a or the like to a high temperature in the power generation chamber 215 and increasing a temperature difference in the upper tube plate 225a or the like. Further, the upper heat insulating body 227a is configured to introduce an exhaust oxidized gas, which has passed through the power generation chamber 215 and exposed to the high temperature, to the oxidant exhaust header 223 through the oxidant exhaust gap 235b.

According to the present embodiment, due to the structure of the fuel cell cartridge 203 described above, the fuel gas and the oxidizing gas oppositely flow inside and outside the single fuel cell 101. Consequently, the exhaust oxidized gas exchanges heat with the fuel gas supplied to the power generation chamber 215 through the inside of the substrate tube 103, is cooled to a temperature at which the upper tube plate 225a or the like made of the metal material is not subjected to deformation such as buckling, and is supplied to the oxidant exhaust header 223. Further, the fuel gas is raised in temperature by the heat exchange with the exhaust oxidized gas exhausted from the power generation chamber 215 and supplied to the power generation chamber 215. As a result, the fuel gas, which is preheated and raised in temperature to a temperature suitable for power generation without using a heater or the like, can be supplied to the power generation chamber 215.

Further, as described above, the upper heat insulating body 227a is designed so as to have not a little gap with the single fuel cell 101 inserted into the oxidant exhaust gap 235b. However, the outer surface of the single fuel cell 101 may contact the upper heat insulating body 227a due to, for example, an influence of thermal expansion during operation. Since the gas seal film 117 of the single fuel cell 101 is located in the range opposite to the upper heat insulating body 227a via the oxidant exhaust gap 235b, even if the outer surface of the single fuel cell 101 contacts the upper heat insulating body 227a, the leakage current Leak caused by the potential difference between the single fuel cell 101 and the upper heat insulating body 227a can more effectively be suppressed by the gas seal film first layer 117a having low electronic conductivity.

Further, the upper heat insulating body 227a may contain colloidal silica for improving workability and Na added for stabilizing colloidal silica. In this case, if the outer surface of the single fuel cell 101 contacts the upper heat insulating body 227a, cations such as Na contained in the upper heat insulating body 227a may move toward the single fuel cell 101 and cause the leakage current Leak. However, with the intervening gas seal film 117 at the said position, it is also possible to effectively suppress such movement of the cations.

The lower tube plate 225b is fixed to side plates of the lower casing 229b such that the lower tube plate 225b, a bottom plate of the lower casing 229b, and the lower heat insulating body 227b are substantially parallel to each other, between the bottom plate of the lower casing 229b and the lower heat insulating body 227b. Further, the lower tube plate 225b has a plurality of holes corresponding to the number of single fuel cells 101 provided in the fuel cell cartridge 203, and the single fuel cells 101 are inserted into the holes, respectively. The lower tube plate 225b is configured to air-tightly support another end portion of each of the plurality of single fuel cells 101 via either or both of the sealing member 237b and the adhesive material, and isolate the fuel gas exhaust header 219 from the oxidant supply header 221.

The lower heat insulating body 227b is disposed at an upper end portion of the lower casing 229b such that the lower heat insulating body 227b, the bottom plate of the lower casing 229b, and the lower tube plate 225b are substantially parallel to each other, and is fixed to the side plates of the lower casing 229b. Further, the lower heat insulating body 227b includes the plurality of oxidant supply gaps 235a corresponding to the number of single fuel cells 101 provided in the fuel cell cartridge 203. Each of the oxidant supply gaps 235a is formed into a hole shape in the lower heat insulating body 227b, and a diameter of the oxidant supply gap 235a is set larger than the outer diameter of the single fuel cell 101 passing through the oxidant supply gap 235a.

The lower heat insulating body 227b is configured to separate the power generation chamber 215 and the oxidant supply header 221, and suppress the increase in corrosion by the oxidizing agent contained in the oxidizing gas or the decrease in strength due to an increased temperature of the atmosphere around the lower tube plate 225b. The lower tube plate 225b or the like is made of the metal material, such as inconel, having high temperature durability, and the lower heat insulating body 227b is configured to prevent thermal deformation which is caused by exposing the lower tube plate 225b or the like to a high temperature and increasing a temperature difference in the lower tube plate 225b or the like. Further, the lower heat insulating body 227b is configured to introduce the oxidizing gas, which is supplied to the oxidant supply header 221, to the power generation chamber 215 through the oxidant supply gap 235a.

According to the present embodiment, due to the structure of the fuel cell cartridge 203 described above, the fuel gas and the oxidizing gas oppositely flow inside and outside the single fuel cell 101. Consequently, the exhaust fuel gas having passed through the power generation chamber 215 through the inside of the substrate tube 103 exchanges heat with the oxidizing gas supplied to the power generation chamber 215, is cooled to a temperature at which the lower tube plate 225b or the like made of the metal material is not subjected to deformation such as buckling, and is supplied to the fuel gas exhaust header 219. Further, the oxidizing gas is raised in temperature by the heat exchange with the exhaust fuel gas and supplied to the power generation chamber 215. As a result, the oxidizing gas, which is raised to a temperature needed for power generation without using the heater or the like, can be supplied to the power generation chamber 215.

Further, as described above, the lower heat insulating body 227b is designed so as to have not a little gap with the single fuel cell 101 inserted into the oxidant supply gap 235a. However, the outer surface of the single fuel cell 101 may contact the lower heat insulating body 227b due to, for example, the influence of thermal expansion during operation. Since the gas seal film 117 of the single fuel cell 101 is located in the range opposite to the lower heat insulating body 227b via the oxidant supply gap 235a, even if the outer surface of the single fuel cell 101 contacts the lower heat insulating body 227b, the leakage current Leak caused by the potential difference between the single fuel cell 101 and the upper heat insulating body 227a can more effectively be suppressed by the gas seal film first layer 117a having low electronic conductivity.

Further, the lower heat insulating body 227b may contain colloidal silica for improving workability and Na added for stabilizing colloidal silica. In this case, if the outer surface of the single fuel cell 101 contacts the lower heat insulating body 227b, cations such as Na contained in the lower heat insulating body 227b may move toward the single fuel cell 101 and cause the leakage current Leak. However, with the intervening gas seal film 117 at the said position, it is also possible to effectively suppress such movement of the cations.

After being derived to the vicinity of the end portion of the single fuel cell 101 by the lead film 115 which is made of Ni/YSZ or the like disposed in the plurality of power generation parts 105, DC power generated in the power generation chamber 215 is collected to a current collector rod (not shown) of the fuel cell cartridge 203 via a current collector plate (not shown), and is taken out of each single fuel cell cartridge 203. The DC power derived to the outside of the fuel cell cartridge 203 by the current collector rod interconnects the generated powers of the respective fuel cell cartridges 203 by a predetermined series number and parallel number, and is derived to the outside, is converted into predetermined AC power by a power conversion device (an inverter or the like) such as a power conditioner (not shown), and is supplied to a power supply destination (for example, a load system or a power system). As for the rest, without departing from the spirit of the present disclosure, it is

possible to replace the constituent elements in the above-described embodiments with known constituent elements, respectively, as needed and further, the above-described embodiments may be combined as needed.

The contents described in the above embodiments would be understood as follows, for instance.

(1) A single fuel cell (such as the single fuel cell 101 of the above-described embodiment) according to one aspect, includes: a power generation part (such as the power generation part 105 of the above-described embodiment) where an anode (such as the anode 109 of the above-described embodiment), an electrolyte (such as the electrolyte 111 of the above-described embodiment), and a cathode (such as the cathode 113 of the above-described embodiment) are stacked; a non-power generation part (such as the non-power generation part 110 of the above-described embodiment) that does not include the power generation part; and a gas seal film (such as the gas seal film 117 of the above-described embodiment) for at least partially covering a surface of the non-power generation part. The gas seal film includes a first layer (such as the first layer 117a of the above-described embodiment) and a second layer (such as the second layer 117b of the above-described embodiment) laminated to each other. The first layer has lower electronic conductivity than the second layer. The second layer has lower oxygen ion conductivity than the first layer.

With the above aspect (1), the gas seal film for covering the surface of the non-power generation part has a laminated structure including the first layer and the second layer. Since the first layer is configured to have lower electronic conductivity than the second layer, it is possible to effectively reduce the leakage current that may be caused by the potential difference between the first layer and the peripheral component. Since the second layer is configured to have the lower oxygen ion conductivity than the first layer, movement of oxygen ions via the gas seal film is suppressed. Since the single fuel cell includes the gas seal film having such configuration, it is possible to suppress the leakage current to the peripheral component while preventing oxygen ions from penetrating from the oxidizing gas side to the fuel gas side.

(2) In another aspect, in the above aspect (1), the second layer is disposed on the first layer.

With the above aspect (2), if the peripheral component contacts the outside of the single fuel cell, the leakage current Leak caused by the potential difference between the single fuel cell 101 and the upper heat insulating body 227a can more effectively be suppressed by the gas seal film first layer 117a having low electronic conductivity.

Further, if the peripheral component contacts the outside of the single fuel cell, the penetration of oxygen ions from the outside of the cell can more effectively be suppressed by interposing the second layer 117b having low oxygen ion conductivity between the first layer 117a and the peripheral component.

(3) In another aspect, in the above aspect (1) or (2), the non-power generation part includes a lead film (such as the lead film 115 of the above-described embodiment) electrically connected to the power generation part located in an end portion, and the gas seal film is configured to at least partially cover a surface of the lead film.

With the above aspect (3), the gas seal film is disposed so as to at least partially cover the surface of the lead film electrically connected to the power generation part located in the starting end portion. Thus, it is possible to effectively suppress the penetration of oxygen ions in the lead film and the occurrence of the leakage current.

(4) In another aspect, in any of the above aspects (1) to (3), the non-power generation part includes an interconnector (such as the interconnector 107 of the above-described embodiment) for electrically connecting the power generation parts, and the gas seal film is configured to at least partially cover a surface of the interconnector.

With the above aspect (4), the gas seal film is disposed so as to at least partially cover the surface of the interconnector for electrically connecting the power generation parts. Thus, it is possible to effectively suppress the penetration of oxygen ions in the interconnector and the occurrence of the leakage current.

(5) In another aspect, in any of the above aspects (1) to (4), the first layer contains stabilized zirconia (general term for homogeneous phase zirconia in which a metal oxide having a different valence from zirconium is solid-dissolved).

With the above aspect (5), since the first layer is configured to contain YSZ having low electronic conductivity, it is possible to obtain the single fuel cell capable of effectively suppressing the leakage current.

(6) In another aspect, in any of the above aspects (1) to (5), the second layer contains MTiO₃ (M: alkaline earth metal).

With the above aspect (6), since the second layer is configured to contain MTiO₃ having low electronic conductivity, it is possible to obtain the single fuel cell capable of effectively suppressing the penetration of oxygen ions from the oxidizing gas side to the fuel gas side.

(7) A fuel cell cartridge (such as the fuel cell cartridge 203 of the above-described embodiment) according to one aspect, includes: the single fuel cell according to any of the above aspects (1) to (6); and a heat insulating body (such as the upper heat insulating body 227a, the lower heat insulating body 227b of the above-described embodiment) surrounding a power generation camber (such as the power generation chamber 215 of the above-described embodiment) including the single fuel cell. The gas seal film is disposed between the surface and the heat insulating body.

With the above aspect (7), the gas seal film having the above configuration is disposed so as to be interposed between the surface of the non-power generation part and the heat insulating body. Thus, when the surface of the non-power generation part where the gas seal film is disposed contacts the heat insulating body, it is possible to effectively suppress the leakage current or the oxygen ion movement between the surface of the non-power generation part and the heat insulating body.

(8) A manufacturing method for a single fuel cell (such as the single fuel cell 101 of the above-described embodiment) according to one aspect, the single fuel cell including: a power generation part (such as the power generation part 105 of the above-described embodiment) where an anode (such as the anode 109 of the above-described embodiment), an electrolyte (such as the electrolyte 111 of the above-described embodiment), and a cathode (such as the cathode 113 of the above-described embodiment) are stacked; a non-power generation part (such as the non-power generation part 110 of the above-described embodiment) that does not include the power generation part; a gas seal film (such as the gas seal film 117 of the above-described embodiment) for at least partially covering a surface of the non-power generation part; and a substrate tube (such as the substrate tube 103 of the above-described embodiment) for supporting the power generation part, the non-power generation part, and the gas seal film, the gas seal film including a first layer (such as the first layer 117a of the above-described embodiment) and a second layer (such as the second layer 117b of the above-described embodiment) laminated to each other, the first layer having lower electronic conductivity than the second layer, the second layer having lower oxygen ion conductivity than the first layer, the manufacturing method for the single fuel cell, including: a slurry application step of applying at least one of a first slurry which is a material constituting the first layer or a second slurry which is a material constituting the second layer onto a surface, of the substrate tube, corresponding to the non-power generation part; and a firing step of firing at least one of the first slurry or the second slurry together with a third slurry which is applied onto a surface, of the substrate tube, corresponding to the power generation part and is a material constituting the anode and the electrolyte.

With the above aspect (8), in the fuel cell having the above configuration, at least one of the first layer and the second layer composing the gas seal film is fired together with the anode and the electrolyte in the power generation part. Since the sintering temperatures of the anode and the electrolyte in the power generation part are relatively high, in this aspect, the gas seal film is formed at a high sintering temperature as well. As a result, it is possible to obtain the gas seal film having a higher density, obtaining the single fuel cell having a good oxygen ion insulating property. In addition, it is also possible to reduce the number of steps for manufacturing the single fuel cell, and thus it is advantageous for cost reduction.

(9) In another aspect, in the above aspect (8), the slurry application step includes applying the first slurry and the second slurry onto the surface, and the firing step includes firing the first slurry and the second slurry together with the third slurry.

With the above aspect (9), both of the first layer and the second layer composing the gas seal film are fired together with the anode and the electrolyte in the power generation part. Thus, it is possible to increase the denseness of both the first layer and the second layer, obtaining the single fuel cell having a better oxygen ion insulating property. In addition, it is possible to further reduce the number of steps for manufacturing the single fuel cell, and it is possible to obtain the single fuel cell having the above configuration at a lower cost.

(10) In another aspect, in the above aspect (8), the slurry application step includes applying one of the first slurry or the second slurry onto the surface, and the firing step includes firing one of the first slurry or the second slurry together with the third slurry.

With the above aspect (10), one of the first layer or the second layer of the gas seal film is fired together with the anode and the electrolyte in the power generation part. By thus firing each layer composing the gas seal film one by one, it is possible to obtain the gas seal film of higher quality.

(11) In another aspect, in the above aspect (10), after the firing step, the gas seal film is formed by applying the other of the first slurry or the second slurry onto the surface of the non-power generation part and firing the other of the first slurry or the second slurry at a temperature lower than a temperature in the firing step.

With the above aspect (11), the other layer, of the gas seal film, which is not fired together with the anode and the electrolyte in the power generation part is fired at a lower firing temperature after the firing step of the one layer. Thus, it is possible to prevent the occurrence of a defect, such as a crack, during firing, and it is possible to obtain the gas seal film of higher quality.

### REFERENCE SIGNS LIST

101 Single fuel cell
103 Substrate tube
105 Power generation part
107 Interconnector
109 Anode
110 Non-power generation part
111 Electrolyte
113 Cathode
115 Lead film
117 Gas seal film
117a First layer
117b Second layer
120 Current collector part
130 Output end
132 Measurement line
134 Withstand voltage tester
136 Power supply
138 Leakage current measurement part
203 Fuel cell cartridge
215 Power generation chamber
217 Fuel gas supply header
219 Fuel gas exhaust header
221 Oxidant supply header
223 Oxidant exhaust header
225a Upper tube plate
225b Lower tube plate
227 Heat insulating body
227a Upper heat insulating body
227b Lower heat insulating body
229a Upper casing
229b Lower casing
231a Fuel gas supply hole
231b Fuel gas exhaust hole
233a Oxidant supply hole
233b Oxidant exhaust hole
235a Oxidant supply gap
235b Oxidant exhaust gap

1. A single fuel cell, comprising:
a power generation part where an anode, an electrolyte, and a cathode are stacked;
a non-power generation part that does not include the power generation part; and
a gas seal film for at least partially covering a surface of the non-power generation part,
wherein the gas seal film includes a first layer and a second layer laminated to each other,
wherein the first layer has lower electronic conductivity than the second layer, and
wherein the second layer has lower oxygen ion conductivity than the first layer.

2. The single fuel cell according to claim 1,
wherein the second layer is disposed on the first layer.

3. The single fuel cell according to claim 1,
wherein the non-power generation part includes a lead film electrically connected to the power generation part located in an end portion, and
wherein the gas seal film is configured to at least partially cover a surface of the lead film.

4. The single fuel cell according to claim 1,
wherein the non-power generation part includes an interconnector for electrically connecting the power generation parts, and
wherein the gas seal film is configured to at least partially cover a surface of the interconnector.

5. The single fuel cell according to claim 1,
wherein the first layer contains stabilized zirconia.

6. The single fuel cell according to claim 1,
wherein the second layer contains MTiO₃ (M: alkaline earth metal).

7. A fuel cell cartridge, comprising:
the single fuel cell according to claim 1; and
a heat insulating body surrounding a power generation chamber including the single fuel cell, wherein the gas seal film is disposed at a position opposite to the heat insulating body.

8. A manufacturing method for a single fuel cell including:
a power generation part where an anode, an electrolyte, and a cathode are stacked;
a non-power generation part that does not include the power generation part;
a gas seal film for at least partially covering a surface of the non-power generation part; and
a substrate tube for supporting the power generation part, the non-power generation part, and the gas seal film,
the gas seal film including a first layer and a second layer laminated to each other, the first layer having lower electronic conductivity than the second layer,
the second layer having lower oxygen ion conductivity than the first layer, the manufacturing method for the single fuel cell, comprising:
a slurry application step of applying at least one of a first slurry which is a material constituting the first layer or a second slurry which is a material constituting the second layer onto a surface, of the substrate tube, corresponding to the non-power generation part; and
a firing step of firing at least one of the first slurry or the second slurry together with a third slurry which is applied onto a surface, of the substrate tube, corresponding to the power generation part and is a material constituting the anode and the electrolyte.

9. The manufacturing method for the single fuel cell according to claim 8,
wherein the slurry application step includes applying the first slurry and the second slurry onto the surface, and
wherein the firing step includes firing the first slurry and the second slurry together with the third slurry.

10. The manufacturing method for the single fuel cell according to claim 8,
wherein the slurry application step includes applying one of the first slurry or the second slurry onto the surface, and
wherein the firing step includes firing one of the first slurry or the second slurry together with the third slurry.

11. The manufacturing method for the single fuel cell according to claim 10,
wherein, after the firing step, the gas seal film is formed by applying the other of the first slurry or the second slurry onto the surface of the non-power generation part and firing the other of the first slurry or the second slurry at a temperature lower than a temperature in the firing step.
